(19) United States
(12) Patent Application Publication
(10) Pub. No.: US 2016/0150595 A1
(43) Pub. Date: May 26, 2016

(54) HEATING SYSTEM AND METHOD OF HEATING A COMPONENT

(71) Applicant: Caterpillar Inc., Peoria, IL (US)

(72) Inventors: Chetan Vilas DAHIWAL, Chennai (IN); Gopalakrishnan KANNIAPPAN, Thiruvannamalai (IN); Anuop UDAYAKUMAR, Chennai (IN)

(73) Assignee: Caterpillar Inc., Peoria, IL (US)

(21) Appl. No.: 14/933,357

(22) Filed: Nov. 5, 2015

(30) Foreign Application Priority Data
Nov. 24, 2014 (IN) 3404/DEL/2014

(51) Int. Cl. H05B 3/44; H05B 6/06; H05B 3/00

(52) U.S. Cl. CPC H05B 3/44; H05B 3/0014; H05B 6/06

(57) ABSTRACT

A heating system for a component having a base portion and an elongate portion extending from the base portion is disclosed. The heating system includes a casing. The casing includes a first cover member disposed partly on a top surface of the base portion. A second cover member is coupled to the first cover member and disposed partly on a bottom surface of the base portion. The first cover member and the second cover member are together configured to removably enclose the elongate portion therein.

The casing further includes a heating member configured to be disposed on the elongate portion. The heating member is configured to selectively heat the elongate portion. The casing further includes an insulating material disposed within the casing and enclosing the heating member therein.

### CLAIM FOR PRIORITY

This application claims benefit of priority of Indian Patent Application No. 3404/DEL/2014, filed Nov. 24, 2014, which is incorporated herein by reference.

### TECHNICAL FIELD

The present disclosure relates to a heating system and a method of heating a component, and more particularly to a heating system and a method of heating a component having a base portion and an elongate portion extending from the base portion.

### BACKGROUND

Machines, such as loaders, dozers, excavators, and the like include a work tool for carrying out various operations. An example of such work tool is a bucket which includes a cutting edge assembly. The cutting edge assembly includes an edge cutting plate and a plurality of adapters mounted on a cutting edge of the edge cutting plate. Teeth or other ground engaging members are detachably mounted on the adapters. Typically, the adapters are welded to the edge cutting plate. The edge cutting plate and the adapters are usually preheated to a desired preheating temperature before welding the adapters on the edge cutting plate. Preheating of the edge cutting plate and the adapters may improve a weld quality in various manners, such as by slowing a cooling rate of the weld and reducing weld distortion.

The known systems for preheating the edge cutting plate and adapters include a furnace having dimensions greater than dimensions of the edge cutting plate assembly. However, such a furnace may entail high capital investment and running costs. Further, furnaces having dimensions and specifications required for preheating may not be easily available. Another known method of preheating includes using an oxyacetylene torch. But, this heating method may lack precise control as it is performed by an operator. Hence, preheating may not be uniform and may lead to an unpredictable quality of the weld.

U.S. Pat. No. 6,328,926 discloses a method of preparing a pouring tube such as a submerged entry nozzle (SEN) for use in a continuous casting machine. The method includes steps of preheating at least one portion of the pouring tube by exposing the pouring tube to intensive radiative heat transfer and installing the preheated pouring tube into a continuous casting machine. The source of intensive radiative heat transfer is a high intensity infrared heat source that is capable of preheating the pouring tube to a temperature of up to 2000° degrees Fahrenheit within seven to ten minutes.

### SUMMARY OF THE DISCLOSURE

In one aspect of the present disclosure, a heating system for a component having a base portion and an elongate portion extending from the base portion is provided. The heating system includes a casing. The casing includes a first cover member disposed partly on a top surface of the base portion. The casing also includes a second cover member coupled to the first cover member and disposed partly on a bottom surface of the base portion. The first cover member and the second cover member are together configured to removably enclose the elongate portion therein. The heating system further includes a heating member configured to be disposed on the elongate portion. The heating member is configured to selectively heat the elongate portion. The heating system also includes an insulating material disposed within the casing and enclosing the heating member therein.

In another aspect of the present disclosure, a heating system for a component having a base portion and an elongate portion extending from the base portion is provided. The heating system includes a casing configured to removably enclose the elongate portion therein. The heating system also includes a first heating member configured to be disposed on the elongate portion. The first heating member is configured to selectively heat the elongate portion. The heating system further includes an insulating material disposed within the casing and enclosing the first heating member therein. The heating system also includes a top plate disposed on a top surface of the base portion and detachably coupled to the base portion. The top plate includes an insulating layer on a surface adjacent to the top surface of the base portion. Further, the heating system includes a bottom plate disposed on a bottom surface of the base portion and detachably coupled to the base portion. The bottom plate includes an insulating layer on a surface adjacent to the bottom surface of the base portion. The heating system also includes a second heating member disposed between the base portion and at least one of the top plate and the bottom plate. The second heating member is configured to selectively heat the base portion.

In yet another aspect of the present disclosure, a method of heating a component having a base portion and an elongate portion extending from the base portion is provided. The method includes providing a first heating member on the elongate portion. The method also includes providing a first cover member partly on a top surface of the base portion and a second cover member partly on a bottom surface of the base portion to enclose the elongate portion therein. The method further includes providing an insulating material within the first cover member and the second cover member to enclose the heating member therein. The method further includes heating the elongate portion of the component via the first heating member.

Other features and aspects of this disclosure will be apparent from the following description and the accompanying drawings.

### BRIEF DESCRIPTION OF THE DRAWINGS

FIG. 1 is a perspective view of a work tool of a machine having a cutting edge assembly;

FIG. 2 is a perspective view of a heating system enclosing the cutting edge assembly shown in FIG. 1, according to an embodiment of the present disclosure;

FIG. 3 is a sectional view of the heating system along with the cutting edge assembly taken along line A-A′ of FIG. 2;

FIG. 4 is a perspective view showing an open configuration of a casing of the heating system including a heating member and an insulating material, according to an embodiment of the present disclosure;

FIG. 5 is a perspective view of a top plate of the heating system, according to an embodiment of the present disclosure;

FIG. 6 is a perspective view of a bottom plate of the heating system, according to an embodiment of the present disclosure;

FIG. 7 is a schematic diagram showing a power supply of the heating system, according to an embodiment of the present disclosure; and

FIG. 8 is a flowchart of a method of heating the cutting edge assembly, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

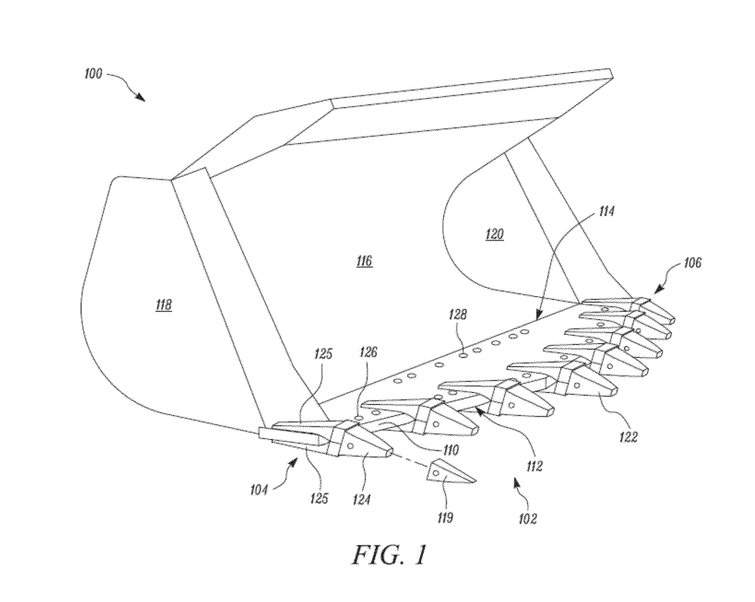

FIG. 1 is a perspective view of an exemplary work tool 100 of a machine (not shown) having a cutting edge assembly 102. The machine may be a dozer, a loader, an excavator, or any other machine that may be used for excavation. The machine includes the work tool 100 for performing earth moving operations such as for excavation, and for loading and unloading earthen material. The work tool 100 may be pivotally attached to a front end and/or a rear end of the machine. The work tool 100 may also be disposed below a frame of the machine such as in a motor grader. In the illustrated embodiment, the work tool 100 is a bucket. In other embodiments, the work tool 100 may be a blade, a dipper and the like.

The work tool 100 includes the cutting edge assembly 102 extending between a first end 104 and a second end 106. The cutting edge assembly 102 is hereinafter referred to as ‘the component 102’. The component 102 includes a base portion 110 having a leading edge 112. The leading edge 112 may extend between the first end 104 and the second end 106 of the component 102. In the illustrated embodiment, the leading edge 112 has a curvilinear shape between the first end 104 and the second end 106. However, it may be contemplated that the leading edge 112 may be straight, or any other shape known in the art. The base portion 110 further includes a trailing edge 114 configured to be connected with a longitudinal wall 116. The longitudinal wall 116 further extends between a first side wall 118 and a second side wall 120 disposed adjacent to the first end 104 and the second end 106 of the component 102, respectively. The trailing edge 114 of the base portion 110 may be connected with the longitudinal wall 116 by one of welding, bolting, clamping, or a combination thereof. The component 102, the longitudinal wall 116, the first side wall 118 and the second side wall 120 may together define a volume to carry earthen material.

The component 102 further includes one or more elongate portions 122 extending from the base portion 110. Each of the elongate portions 122 may be an adapter configured to be detachably connected with a corresponding tooth 119. The tooth 119 may perform an excavating operation. As shown in FIG. 1, the elongate portion 122 includes a body 124 and two legs 125 extending from the body 124. The two legs 125 are configured to be coupled with the base portion 110. The body 124 may have a tapered shape configured to be engaged with a corresponding portion defined in the tooth 119. One or more locking devices (not shown) may detachably connect the tooth 119 to the elongate portion 122.

Referring to FIG. 1, the elongate portions 122 are coupled to the leading edge 112 of the base portion 110. Specifically, the legs 125 of each of the elongate portions 122 are coupled to the base portion 110. A distance between two adjacent elongate portions 122 may be substantially equal. Alternatively, the distance between two adjacent elongate portions 122 may vary depending on the application and a shape of the leading edge 112. The base portion 110 further defines a plurality of through holes 126 adjacent to the leading edge 112 and between two adjacent elongate portions 122. Further, a plurality of through holes 128 is defined in the base portion 110 adjacent to the trailing edge 114. The plurality of holes 126 and 128 may be adapted to attach sacrificial members (e.g., shrouds and wear segments) with the component 102 via fastening members such as bolts and nuts, clamping devices, and the like.

The elongate portions 122 may be coupled to the leading edge 112 of the base portion 110 via welding. Specifically, the legs 125 may be welded to the base portion 110. During manufacturing of the component 102, the legs 125 of each of the elongate portions 122 are engaged with the base portion 110 adjacent to the leading edge 112. The component 102 including the base portion 110 and the elongate portions 122 is preheated by a heating system 130 at a desired preheating temperature before welding the legs 125 to the base portion 110. In addition to welding, preheating may be carried out for various other operations like brazing, soldering and the like. Further, preheating of the component 102 may facilitate lower cooling rate in base metal and weld metal, which ultimately avoids cracking and reduces shrinkage stress in the weld and adjacent base metal. Additionally, insulation material, such as glass wool, may be used for lowering the cooling rate in the base metal and the weld metal. The heating system 130 will be described hereinafter in detail.

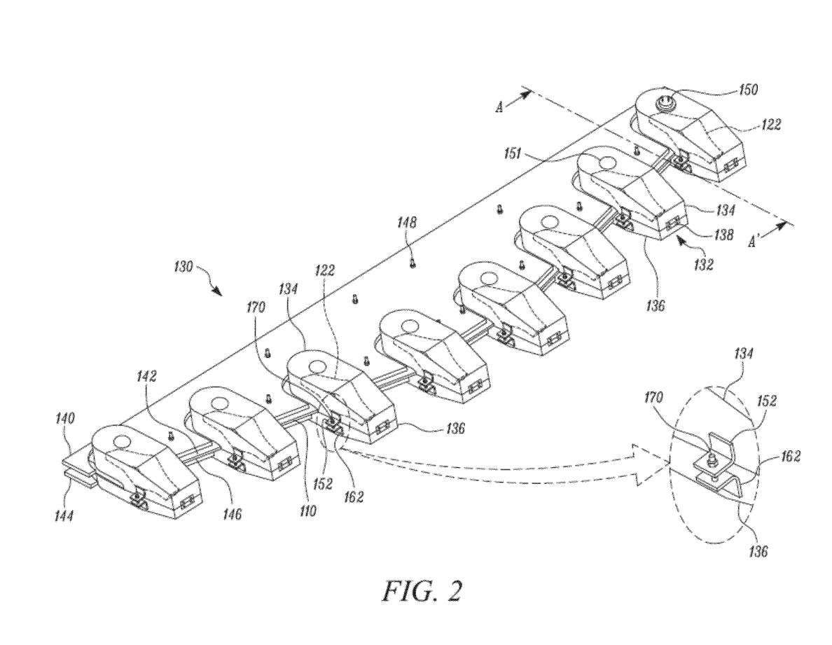

FIG. 2 illustrates a perspective view of the heating system 130 enclosing the component 102, according to an embodiment of the present disclosure. The heating system 130 is configured to enclose the base portion 110 and the elongate portions 122. The heating system 130 includes a casing 132 configured to removably enclose each of the elongate portions 122. The casing 132 includes a first cover member 134 and a second cover member 136 coupled to the first cover member 134. The first cover member 134 and the second cover member 136 are pivotally coupled to each other. Specifically, the first cover member 134 and the second cover member 136 are coupled to a pivot member 138. The pivot member 138 may allow the first cover member 134 and the second cover member 136 to move relative to each other. In various embodiments, the pivot member 138 may be a hinge, a deformable strip, and the like. Further, the first cover member 134 and the second cover member 136 are together configured to removably enclose the elongate portion 122.

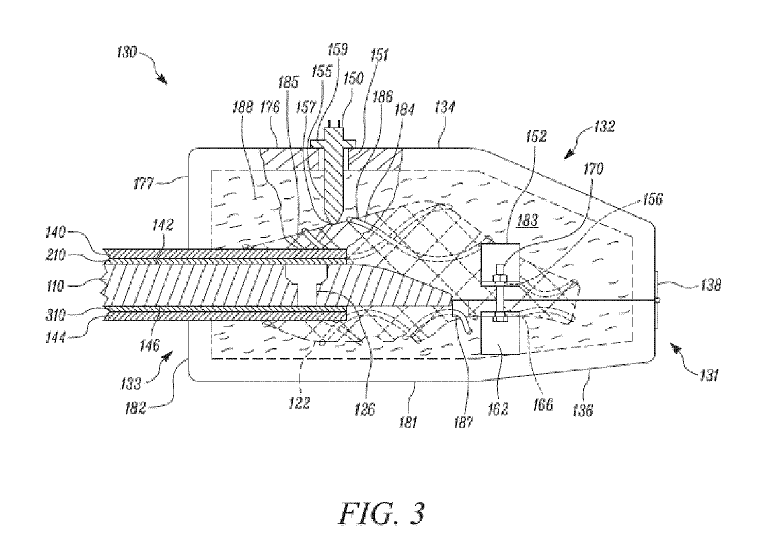

Referring to an enlarged view of the casing 132 in the FIG. 2, the casing 132 further includes a first bracket member 152 mounted on the first cover member 134. The first bracket member 152 is substantially L-shape and defines an aperture 156 (shown in FIG. 3) therethrough. The casing 132 further includes a second bracket member 162 mounted on the second cover member 136. The second bracket member 162 is substantially L-shape and defines an aperture 166 (shown in FIG. 3) therethrough. In an enclosed position of the casing 132, as illustrated in FIG. 2, the apertures 156 and 166 of the first and second bracket members 152, 162, respectively, may be aligned with each other to receive a fastening member 170 therethrough. The fastening member 170 is adapted to prevent relative movement between the first cover member 134 and the second cover member 136. In the illustrated embodiment, the fastening member 170 may include a bolt and a nut. In the enclosed position of the casing 132, the bolt may be inserted through the apertures 156 and 166 and the nut may be engaged with the bolt. Further, the bolt and the nut may be tightened to prevent relative movement between the first cover member 134 and the second cover member 136.

Although the casing 132 includes the first bracket member 152, the second bracket member 162 and the fastening member 170 to prevent relative movement between the first cover member 134 and the second cover member 136, it may be contemplated that any alternative fastening device may be used, for example, a snap-fit coupling, a latch, and the like.

The heating system 130 further includes a temperature sensing device 150 configured to be in contact with the elongate portion 122. In an embodiment, the first cover member 134 of the casing 132 may include an aperture 151 to receive the temperature sensing device 150 therethrough. In other embodiments, the aperture 151 may be defined at any location of the casing 132 to receive the temperature sensing device 150 therethrough. Though in FIG. 1, only one of the casings 132 is shown with the temperature sensing device 150, the temperature sensing device 150 may be coupled to each of the casings 132.

The heating system 130 further includes a top plate 140 disposed on a top surface 142 of the base portion 110. The top plate 140 may have a shape and dimensions configured to cover an entire area of the top surface 142 of the base portion 110. The top plate 140 is further detachably coupled to the top surface 142 of the base portion 110. The heating system 130 further includes a bottom plate 144 disposed on a bottom surface 146 of the base portion 110. The bottom plate 144 may have a shape and dimensions configured to cover an entire area of the bottom surface 146 of the base portion 110. The bottom plate 144 is further detachably coupled to the bottom surface 146 of the base portion 110. In an embodiment, each of the top plate 140 and the bottom plate 144 may be a single integral member. In other embodiments, the top plate 140 and the bottom plate 144 may include multiple members adapted to be coupled to the top surface 142 and the bottom surface 146, respectively. Further, the top plate 140 and the bottom plate 144 may be made from a metal or a metallic alloy.

Each of the top plate 140 and the bottom plate 144 includes a plurality of openings corresponding to the through holes 126 and 128 of the base portion 110. Thus, the top plate 140 and the bottom plate 144 are detachably coupled to the top surface 142 and the bottom surface 146 of the base portion 110, respectively, via a plurality of fastening members 148 such as bolts and nuts.

FIG. 3 shows a sectional view of the heating system 130 along with the component 102 taken along line A-A′ of FIG. 2. The casing 132 may extend between a first end 131 and a second end 133 configured to enclose the elongate portion 122. The first cover member 134 is disposed partly on the top surface 142 of the base portion 110. The first cover member 134 includes an upper wall 176 and a side wall 177 extending from the upper wall 176. Thus, the upper wall 176 and the side wall 177 may be configured to define a volume therein. Similarly, the second cover member 136 is disposed partly on the bottom surface 146 of the base portion 110. The second cover member 136 includes an upper wall 181 and a side wall 182 extending from the upper wall 181. Thus, the upper wall 181 and the side wall 182 may be configured to define a volume therein.

In an embodiment, the first cover member 134 and the second cover member 136 may have a uniform wall thickness ‘T’. Further, the first cover member 134 and the second cover member 136 may be made from a metal or a metallic alloy.

In the enclosed position of the casing 132, the first cover member 134 and the second cover member 136 may define a space 183 surrounding the elongate portion 122 and a portion of the base portion 110. The heating system 130 also includes a first heating member 184 configured to be disposed on the elongate portion 122. Specifically, the first heating member 184 may be disposed within the space 183 proximate to an outer surface 186 of the elongate portion 122. The first heating member 184 may be disposed on the body 124 and the legs 125 of the elongate portion 122. In the illustrated embodiment, the first heating member 184 may be a resistance heating coil. In various other embodiments, the first heating member 184 may be a conduit configured to transport heated fluids, such as hot water, oil, and the like. The first heating member 184 is configured to selectively heat the elongate portion 122. In the illustrated embodiment, the first heating member 184 may be disposed on each of the elongate portions 122 within the corresponding casing 132. The first heating member 184 in each of the casings 132 may be connected in series. At least one of the first cover member 134 and the second cover member 136 defines at least one opening 187 to allow the first heating member 184 to pass therethrough. In an embodiment, the casing 132 includes a pair of such openings 187. The openings 187 may be defined at any location of the casing 132 to allow the first heating member 184 to pass therethrough. The first heating member 184 disposed within each of the casings 132 may be received through the pair of openings 187 to connect with the first heating member 184 disposed on the adjacent casings 132.

The heating system 130 further includes a mesh 185 coupled to at least one of the first cover member 134 and the second cover member 136. The mesh 185 is configured to secure the first heating member 184 to at least one of the first cover member 134 and the second cover member 136. The mesh 185 may be coupled to one of the first cover member 134 and the second cover member 136 by one of welding and clamping. Further, the mesh 185 may have a shape substantially similar to the outer surface 186 of the body 124 and legs 125 of the elongate portion 122 such that the first heating member 184 may be disposed proximate to the outer surface 186 of the elongate portion 122.

The heating system 130 further includes an insulating material 188 disposed within the casing 132 and enclosing the first heating member 184 therein. The insulating material 188 is disposed within the space 183 so as to surround the first heating member 184 and, at least partly, the outer surface 186 of the elongate portion 122. The insulating material 188 may reduce dissipation of heat from the first heating member 184 and the elongate portion 122. Further, heat emitted by the first heating member 184 may be substantially used for heating the elongate portion 122. In the illustrated embodiment, the insulating material 188 is glass wool. However, it may be contemplated that any insulating material known in the art may be disposed within the casing 132 to reduce dissipation of heat from the first heating member 184 and the elongate portion 122.

Referring to FIG. 3, the temperature sensing device 150 is received through the aperture 151 defined on the upper wall 176 of the first cover member 134. In the illustrated embodiment, the temperature sensing device 150 is a thermocouple. The temperature sensing device 150 includes an elongate member 155 defining a temperature sensing tip 157. The temperature sensing tip 157 is configured to be in contact with the outer surface 186 of the elongate portion 122. In an embodiment, the elongate member 155 may have a flange 159 coupled with the casing 132 by a fastening device (not shown).

The temperature sensing tip 157 may extend through the insulating material 188 to contact the outer surface 186 of the elongate portion 122. In another embodiment, the elongate member 155 may be inserted freely through the aperture 151 such that the temperature sensing tip 157 contacts the outer surface 186 of the elongate portion 122. It may be contemplated that the temperature sensing device 150 may be any temperature sensing device known in the art. The temperature sensing device 150 is configured to generate signal indicative of a temperature within the casing 132. In an embodiment, the temperature sensing device 150 may generate a single indicative of a temperature of the outer surface 186 of the elongate portion 122. In other embodiments, the temperature may correspond to a temperature at any point within the casing 132.

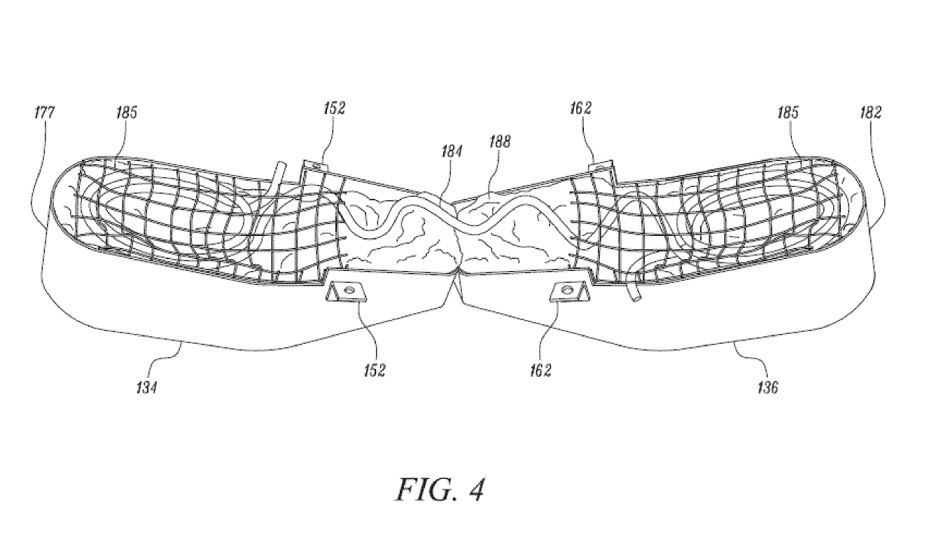

FIG. 4 is illustrates one of the casings 132 in an open configuration, according to an embodiment of the present disclosure. In the open configuration, the first cover member 134 and the second cover member 136 are moved relative to each other about the pivot member 138. Referring to FIG. 4, a space defined by each of the first cover member 134 and the second cover member 136 includes the insulating material 188. The first heating member 184 is disposed over the insulating material 188 in the form of a pair of coils. Each coil is disposed in one of the first cover member 134 and the second cover member 136. Further, each of the coils includes one or more loops. This may increase a surface area of the first heating member 184 disposed inside the casing 132, and hence increase an amount of heat provided by the first heating member 184. The number and/or dimensions of the loops in the first cover member 134 and the second cover member 136 may be designed according to the various parameters including, but not limited to, a cross-sectional area of the first heating member 184, material and/or dimensions of the elongate portion 122 and the desired preheating temperature.

The coil of the first heating member 184 disposed in the first cover member 134 may be secured by the mesh 185. Similarly, the coil of the first heating member 184 disposed in the second cover member 136 may be secured by another mesh 185. In the illustrated embodiment, the mesh 185 is welded to the side walls 177 and 182 of the respective first cover member 134 and second cover member 136, respectively. Further, the shapes of the respective meshes 185 may be substantially similar to the respective portions of the outer surface 186 of the elongate portion 122. As a result, the coils of the first heating member 184 may be optimally distributed proximate to the outer surface 186 of the elongate portion 122 to provide uniform heating. In the illustrated embodiment, the mesh 185 may be a rectangular mesh. However, it may be contemplated that any other type of mesh known in the art may be coupled to one of the first cover member 134 and the second cover member 136 to secure the first heating member 184.

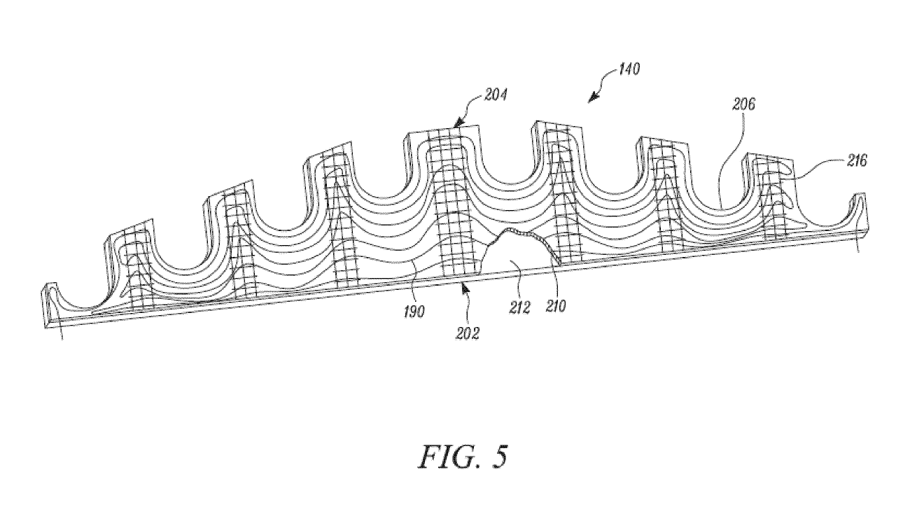

FIG. 5 shows a perspective view of the top plate 140 of the heating system 130, according to an embodiment of the present disclosure. The top plate 140 includes a first edge 202 and a second edge 204 configured to be disposed on the trailing edge 114 and the leading edge 112 of the base portion 110, respectively. Thus, the top plate 140 including the first edge 202 and the second edge 204 configured to cover the entire area of the top surface 142 of the base portion 110. Further, the top plate 140 defines a first cutout 206 to facilitate mounting of the casing 132 on the component 102. Specifically, the first cutout 206 is defined adjacent to the second edge 204 of the top plate 140. In the illustrated embodiment, the top plate 140 includes a plurality of the first cutouts 206 corresponding to the plurality of casings 132 in the heating system 130. In an embodiment, the first cutout 206 may have a shape complimentary to an outer perimeter of the first cover member 134 in contact with the top surface 142 of the base portion 110. Further, the size of the first cutout 206 may be larger than the outer perimeter of the first cover member 134 such that a clearance may be defined between the casing 132 and the top plate 140.

The top plate 140 further includes an insulating layer 210 on a surface 212 adjacent to the top surface 142 of the base portion 110. The surface 212 may be an inner surface of the top plate 140 adapted to abut the top surface 142 of the base portion 110. The insulating layer 210 may have a thickness ‘T1’ throughout the surface 212.

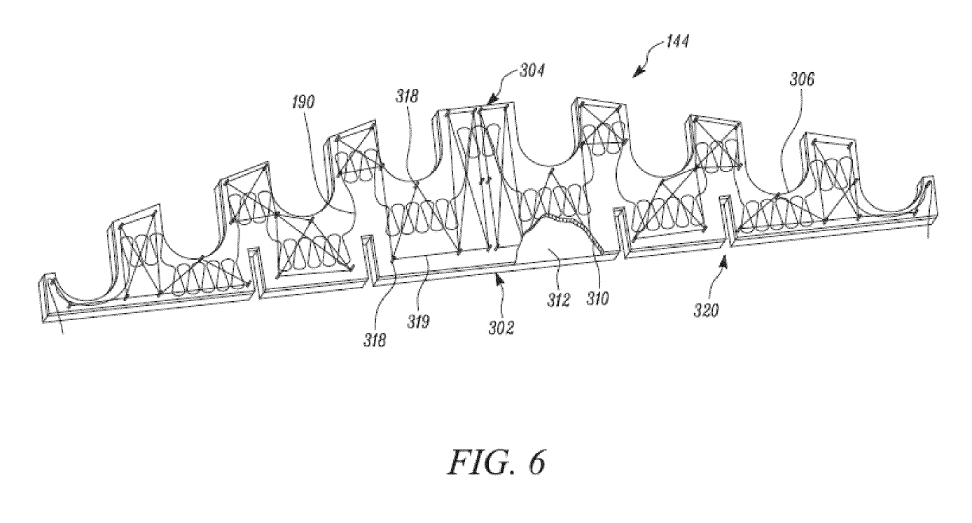

FIG. 6 shows a perspective view of the bottom plate 144 of the heating system 130, according to an embodiment of the present disclosure. The bottom plate 144 includes a first edge 302 and a second edge 304 configured to be disposed on the trailing edge 114 and the leading edge 112 of the base portion 110, respectively. Thus the bottom plate 144 including the first edge 302 and the second edge 304 configured to cover the entire area of the bottom surface 146 of the base portion 110. Further, the bottom plate 144 defines a first cutout 306 to facilitate mounting of the casing 132 on the component 102. Specifically, the first cutout 306 is defined adjacent to the second edge 304 of the bottom plate 144. In the illustrated embodiment, the bottom plate 144 defines a plurality of the first cutouts 306 corresponding to the plurality of casings 132 in the heating system 130. In an embodiment, the first cutout 306 may have a shape complimentary to an outer perimeter of the second cover member 136 in contact with the bottom surface 146 of the base portion 110. Further, the size of the first cutout 306 may be larger than the outer perimeter of the second cover member 136 such that a clearance may be defined between the casing 132 and the bottom plate 144.

The bottom plate 144 further includes an insulating layer 310 on a surface 312 adjacent to the bottom surface 146 of the base portion 110. The surface 312 may be an inner surface of the bottom plate 144 adapted to abut the bottom surface 146 of the base portion 110. The insulating layer 310 may have a thickness ‘T2’ throughout the surface 312.

Referring to FIGS. 5 and 6, at least one of the top plate 140 and the bottom plate 144 defines a second cutout 320 to facilitate mounting of the base portion 110 on a fixture (e.g., a welding manipulator). In the illustrated embodiment, the bottom plate 144 defines the second cutout 320 adjacent to the first edge 302 thereof. Further, the bottom plate 144 may define a plurality of such second cutouts 320 adapted to facilitate mounting of the base portion 110 on the fixture. The second cutout 320 may have a shape complementary to a shape of a mounting member of the fixture. Further, one of the top plate 140 and the bottom plate 144 may include one or more apertures (not shown) corresponding to apertures of the mounting member of the fixture such that the base portion 110 may be coupled with the mounting member via fastening members, such as bolts and nuts.

The heating system 130 further includes the second heating member 190 disposed between the base portion 110 and at least one of the top plate 140 and the bottom plate 144. Further, the second heating member 190 is configured to selectively heat the base portion 110. In an embodiment, a mesh 216 is coupled to at least one of the top plate 140 and the bottom plate 144. The mesh 216 is configured to secure the second heating member 190 to at least one of the top plate 140 and the bottom plate 144. In the illustrated embodiment, the mesh 216 is coupled to the top plate 140 to secure the second heating member 190 to the top plate 140. In another embodiment, a plurality of connectors 318 is disposed on at least one of the top plate 140 and the bottom plate 144. Further, a wire 319 is routed around the connectors 318. The wire 319 is configured to secure the second heating member 190 to at least one of the top plate 140 and the bottom plate 144. In the illustrated embodiment, the plurality of connectors 318 is coupled to the bottom plate 144 to secure the second heating member 190 to the bottom plate 144.

In an embodiment, the second heating member 190 may be a resistance heating coil. In various other embodiments, the second heating member 190 may be a conduit configured to transport heated fluids, such as hot water, oil, and the like. The insulating layers 210 and 310 disposed on the top plate 140 and the bottom plate 144, respectively, may be configured to reduce dissipation of heat from the second heating member 190, and the top and bottom plates, 140, 144. The thickness ‘T1’ of the insulating layer 210 and the thickness ‘T2’ of the insulating layer 310 may vary depending on a temperature of the second heating member 190 at which the base portion 110 is heated. The insulating layers 210, 310 may be made from an insulating material such as glass wool. However, it may be contemplated that any insulating material known in the art may be disposed on the top and bottom plates 140, 144 to reduce dissipation of heat from the second heating member 190, and the top and bottom plates, 140, 144.

Referring to FIG. 5, the second heating member 190 may be optimally distributed in a pattern over the insulating layer 210 of the top plate 140 to uniformly heat the top surface 142 of the base portion 110. In an embodiment, the pattern of the second heating member 190 on the top plate 140 may be designed according to the various parameters including, but not limited to, a cross-sectional diameter of the second heating member 190, material and/or dimensions of the top surface 142, and the desired preheating temperature. One or more meshes 216 may be disposed over the second heating member 190 and coupled between the first edge 202 and the second edge 204. In an embodiment, the meshes 216 may be welded or clamped to the top plate 140.

Referring to FIG. 6, the second heating member 190 may be optimally distributed in a pattern over the insulating layer 310 of the bottom plate 144 to uniformly heat the bottom surface 146 of the base portion 110. In an embodiment, the pattern of the second heating member 190 on the bottom plate 144 may be designed according to the various parameters including, but not limited to, the cross sectional diameter of the second heating member 190, material and/or dimensions of the bottom surface 146, and the desired preheating temperature. Each of the plurality of connectors 318 may be attached to the surface 312 of the bottom plate 144. One or more wires 319 may be disposed over the second heating member 190, and routed around the connectors 318 to secure the second heating member 190 on the bottom plate 144. The wires 319 may be detachably secured to the connectors 318. In an example, the connectors 318 may be snap-fit connectors.

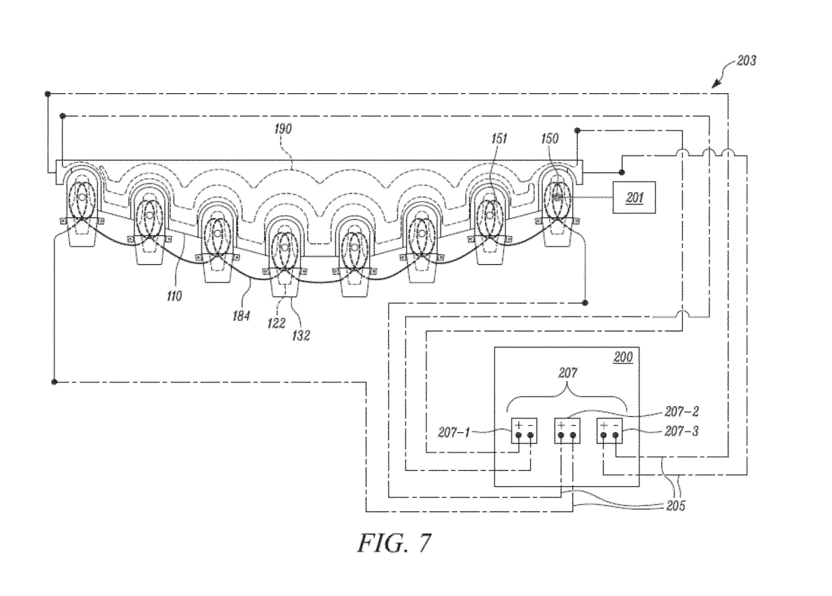

FIG. 7 illustrates a schematic diagram of a power supply 203 of the heating system 130, according to an embodiment of the present disclosure. The power supply 203 includes a power source 200 connected to the first heating member 184 and the second heating member 190 via connecting members 205. The power source 200 is configured to selectively supply power to the first heating member 184 and the second heating member 190. In an embodiment, the power source 200 may be an electric power source and the connecting members 205 may be wires. For example, a 16 KVA power source may be used for heating the first heating member 184 and the second heating member 190.

The power source 200 includes one or more power outlets 207. The power outlets 207 may be coupled with the first heating member 184 and the second heating members 190. Each of the power outlets 207 may be configured to supply different power outputs.

In the illustrated embodiment, the power source 200 includes a first power outlet 207-1, a second power outlet 207-2 and a third power outlet 207-3 configured to supply different power outputs. In other embodiments, the power source 200 may include six power outlets 207 or nine power outlets 207, which may be selectively used for supplying power for various applications. In another embodiment, the power source 200 may be a heat source (e.g., a boiler) known in the art and the connecting members 205 may be conduits configured to transport heated fluids.

The first heating member 184 disposed within each of the casings 132 corresponding to the plurality of elongate portions 122 may be connected in series. Further, a negative terminal and a positive terminal of the first heating member 184 may be connected to the second power outlet 207-2 of the power source 200. The top plate 140 and the bottom plate 144 include separate second heating members 190. A negative terminal and a positive terminal of the second heating member 190 which is disposed on the top plate 140 may be connected to the first power outlet 207-1 of the power source 200. Similarly, a negative terminal and a positive terminal of the second heating member 190 which is disposed on the bottom plate 144 may be connected to the third power outlet 207-3 of the power source 200. The power source 200 may be operated to activate the first heating member 184 and the second heating members 190. In various embodiments, the power source 200 may be regulated automatically or manually.

Referring to FIG. 7, the temperature sensing device 150 for sensing temperature of one of the elongate portions 122 is shown for illustrative purposes. However, it may be contemplated that the temperature sensing device 150 may be inserted through the apertures 151 of each of the casings 132 for sensing temperature of the corresponding elongate portions 122. The power supply 203 further includes a display device 201. The display device 201 is configured to connect with the temperature sensing device 150. The display device 201 is further configured to display the temperature value of the elongate portions 122 based on the signals received from the respective temperature sensing devices 150. In an example, the display device 201 may be a multimeter connected to the temperature sensing devices 150 for displaying the temperature value of the elongate portions 122.

### INDUSTRIAL APPLICABILITY

The present disclosure relates to the heating system 130 associated with manufacturing of the component 102 of the work tool 100. The base portion 110 and the elongate portion 122 are heated to respective desired preheating temperatures before welding the elongate portion 122 on the base portion 110. The heating system 130 including the first heating member 184 and the second heating member 190 are disposed on the elongate portion 122 and the base portion 110, respectively. Further, the power source 200 is configured to supply an electric power to the first and second heating members 184, 190 to heat the elongate portion 122 and the base portion 110 to the desired preheating temperatures.

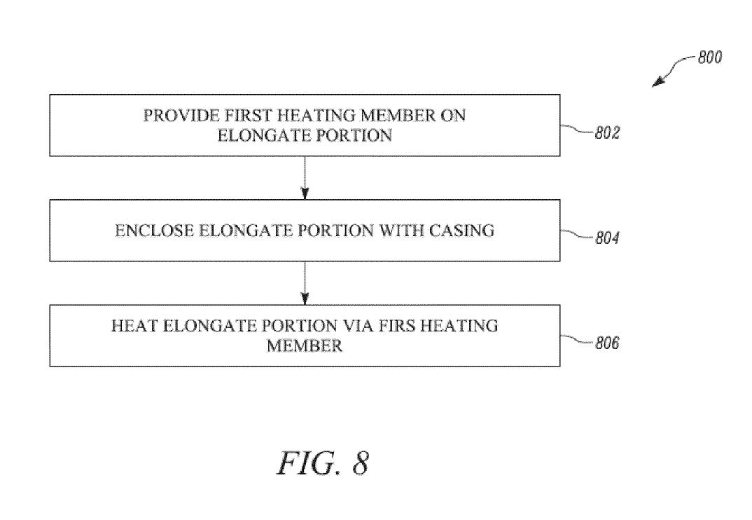

FIG. 8 shows a flowchart of a method 800 of heating the component 102, according to an embodiment of the present disclosure. The method 800 may be described herein below in detail by referring to various steps of heating the component 102. In an embodiment, at step 802, the method 800 includes providing the first heating member 184 on the elongate portion 122. Further, the coils of the first heating member 184 may be optimally distributed on the outer surface 186 of the elongate portion 122 such that heat generated by the first heating member 184 may be uniformly distributed over the outer surface 186. The first heating members 184 disposed on each of the elongate portions 122 are connected in series. Further, each of the first heating members 184 may have a similar configuration such that each of the elongate portions 122 is heated equally.

At step 804, the method includes enclosing the elongate portion 122 with the casing 132. The casing 132 is configured to secure the first heating member 184 on the outer surface 186 of the elongate portion 122. In the illustrated embodiment, the casing 132 includes the first cover member 134 and the second cover member 136 coupled each other to enclose the elongate portion 122. The mesh 185 coupled to the first cover member 134 and the second cover member 136 may be configured to secure the first heating member 184 on the outer surface 186 of the elongate portion 122. The first bracket member 152 disposed on the first cover member 134 and the second bracket member 162 disposed on the second cover member 136 may be coupled by the fastening member 170 to prevent relative movement between the first cover member 134 and the second cover member 136. Further, in the enclosed condition, the casing 132 defines the space 183 surrounding the first heating member 184.

In an alternative embodiment, the casing 132 may be an integral component defining a hollow space configured to receive the elongate portion 122 therein. The casing 132 may be further adapted to be partially disposed on the top surface 142 and the bottom surface 146 of the base portion 110. The casing 132 may be disposed on the elongate portion 122 to enclose the elongate portion 122 along with the first heating member 184 disposed on the outer surface 186 thereon. In various other embodiments, the casing 132 of the heating system 130 may be assembled in two or more assembly steps. It may be contemplated that a sequence of such steps may be varied according to design of various components associated with the casing 132.

The method 800 further includes providing the insulating material 188 within the casings 132 to enclose the first heating member 184 therein. Specifically, the insulating material 188 is disposed within the space 183 defined by the first cover member 134 and the second cover member 136. The insulating material 188 is disposed within the casing 132 surrounding the first heating member 184 to reduce heat loss during heating of the elongate portion 122.

In an exemplary embodiment, a method of assembling one of the casings 132 is described in detail herein below. The first cover member 134 of the casing 132 may be positioned in a work surface for an operator to conveniently work on the first cover member 134. The insulating material 188 is then filled in the portion of the space 183 defined by the first cover member 134. The first heating member 184 is optimally disposed on a surface defined by the insulating material 188 within the first cover member 134. The mesh 185 is then positioned within the first cover member 134 to secure the first heating member 184 within the first cover member 134. The mesh 185 is further welded to the side wall 177 of the first cover member 134. Similarly, the second cover member 136 is assembled and coupled with the first cover member 134 via the pivot member 138. The casing 132 is then disposed on the elongate portion 122 such that the first heating member 184 is optimally distributed over the outer surface 186 of the elongate portion 122.

At step 806, the method 800 includes heating the elongate portion 122 of the component 102 via the first heating member 184. The first heating member 184 connected to the power source 200 may be activated by switching on the power source 200. In an example, each of the first heating members 184 may provide substantially equal heating to the respective elongate portions 122 as the first heating members 184 are connected in series and have a similar configuration. Further, the insulating material 188 may reduce heat dissipation from the first heating members 184 and the elongate portions 122. Hence, a desired preheating temperature of the elongate portions 122 may be achieved in a short duration with higher efficiency. Further, the coils of the first heating members 184 may be optimally distributed on the outer surface 186 of each of the elongate portions 122 in order to provide uniform heating of each of the elongate portions 122. It may be contemplated that a material, dimensions, and/or shape of the first heating members 184 and the casing 132 may be suitably chosen as per the heating requirements of the elongate portions 122. Similarly, an amount and type of the insulating material 188 may also be suitably chosen. The temperature sensing device 150 in contact with the elongate portion 122 may send signals indicative of the temperature of the elongate portion 122. The display device 201 may then selectively display the temperature of the elongate portions 122. Further, electric power supplied by the power source 200 to the first heating members 184 may be regulated based on the temperature detected by the temperature sensing devices 150.

The method 800 further includes providing the second heating member 190 on the top surface 142 and the bottom surface 146 of the base portion 110. The second heating member 190 may be optimally distributed on the top and bottom surfaces 142, 146 of the base portion 110 in order to provide uniform heating over the top and bottom surfaces 142, 146. Further, the top plate 140 and the bottom plate 144 are provided on the top surface 142 and the bottom surface 146 of the base portion 110, respectively. The mesh 216 coupled to the top plate 140 secures the second heating member 190 on the top surface 142, while the wire 319 and the connectors 318 disposed on the bottom plate 144 may secure the second heating member 190 on the bottom surface 146. The insulating layers 210 and 310 attached to the surfaces 212 and 312 of the top plate 140 and the bottom plate 144, respectively, may reduce heat loss during heating the base portion 110.

In an exemplary embodiment, a method of assembling the top plate 140 on the base portion 110 is described in detail herein below. The top plate 140 may be positioned on a work surface for the operator to conveniently work on the top plate 140. The insulating layer 210 is disposed on the surface 212 of the top plate 140. The second heating member 190 is optimally disposed on a surface defined by the insulating layer 210. The mesh 216 is then disposed on the second heating member 190 and welded to the first edge 202 and the second edge 204 of the top plate 140. Thus the second heating member 190 may be secured to the top plate 140. Similarly, the bottom plate 144 is also assembled. The top plate 140 and the bottom plate 144 are coupled to the top surface 142 and the bottom surface 146 of the base portion 110, respectively, via the fastening members 148. In various other embodiments, the top and the bottom plates 140, 144 of the heating system 130 may be assembled in two or more assembly steps. It may be contemplated that a sequence of such steps may be varied according to design of various components associated with the top and the bottom plates 140, 144.

Further, the base portion 110 of the component 102 is heated via the second heating member 190. The second heating member 190, connected to the power source 200, may be activated by operating the power source 200.

The heating system 130 according to the present disclosure may heat the elongate portion 122 and the base portion 110 to the desired preheating temperature in short duration and with higher efficiency. Moreover, the desired preheating temperature is achieved in very short duration as the first and second heating members 184, 190 are in direct contact with the outer surface 186 of the elongate portion 122 and top and bottom surfaces 142, 146 of the base portion 110. Further, the insulating material 188 disposed within the casing 132 and the insulating layers 210 and 310 attached to the top and bottom plates 140, 144, respectively, may facilitate heating the component 102 in very short duration by reducing the heat dissipation within the casing 132 and the top and bottom plates 140, 144. Further, electric power supplied by the power source 200 to the second heating members 190 may be regulated as per heating requirements.

The second cutouts 320 provided on the bottom plate 144 may facilitate mounting the component 102 enclosed in the heating system 130 to the mounting member of the fixture. The mounting member may be moved to various angular positions about a pivot point of the fixture such that the component 102 may be oriented to a convenient position for an operator to weld the elongate portion 122 to the base portion 110. In an example, after welding the elongate portion 122 to the base portion 110, the component 102 may be enclosed in the heating system 130 for facilitating slow cooling of the component 102 as the insulating material 188 and the insulating layers 210, 310 may restrict heat dissipation from the elongate portions 122, and the top and bottom plates 140, 144, respectively. Though the heating system 130 is described with respect to the component 102 of the work tool 100, the heating system 130 may be modified to heat various other types of components, such as a cutting edge of a dipper, a ripper attachment, and the like. Further, the heating system 130 may enable consistent heating of a plurality of such components 102, thereby ensuring repeatability of the welding operation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

We claim:

1. A heating system for a component having a base portion and an elongate portion extending from the base portion, the heating system comprising:
a casing comprising:
a first cover member disposed partly on a top surface of the base portion; and
a second cover member coupled to the first cover member and disposed partly on a bottom surface of the base portion, wherein the first cover member and the second cover member are together configured to removably enclose the elongate portion therein;
a heating member configured to be disposed on the elongate portion, the heating member configured to selectively heat the elongate portion; and
an insulating material disposed within the casing and enclosing the heating member therein.

2. The heating system of claim 1, wherein at least one of the first cover member and the second cover member defines an opening to allow the heating member to pass therethrough.

3. The heating system of claim 1, further comprising a power source connected to the heating member, the power source configured to selectively supply power to the heating member.

4. The heating system of claim 1, wherein the heating member is a resistance heating coil.

5. The heating system of claim 1, wherein the first cover member and the second cover member are pivotally coupled to each other.

6. The heating system of claim 1, wherein the casing further comprising:
a first bracket member disposed on the first cover member, the first bracket member defining an aperture therethrough;
a second bracket member disposed on the second cover member, the second bracket member defining an aperture therethrough; and
a fastening member received in the apertures of the first bracket member and the second bracket member, the fastening member adapted to prevent relative movement between the first cover member and the second cover member.

7. The heating system of claim 1, further comprising a mesh coupled to at least one of the first cover member and the second cover member, the mesh configured to secure the heating member to at least one of the first cover member and the second cover member.

8. The heating system of claim 1, further comprising a temperature sensing device configured to be in contact with an outer surface of the elongate portion, wherein the temperature sensing device is configured to generate signal indicative of a temperature of the outer surface of the elongate portion.

9. A heating system for a component having a base portion and an elongate portion extending from the base portion, the heating system comprising:
a casing configured to removably enclose the elongate portion therein;
a first heating member configured to be disposed on the elongate portion, the first heating member configured to selectively heat the elongate portion;
an insulating material disposed within the casing and enclosing the first heating member therein.
a top plate disposed on a top surface of the base portion and detachably coupled to the base portion, the top plate comprising an insulating layer on a surface adjacent to the top surface of the base portion;
a bottom plate disposed on a bottom surface of the base portion and detachably coupled to the base portion, the bottom plate comprising an insulating layer on a surface adjacent to the bottom surface of the base portion; and
a second heating member disposed between the base portion and at least one of the top plate and the bottom plate, the second heating member configured to selectively heat the base portion.

10. The heating system of claim 9, wherein the casing comprising:
a first cover member disposed partly on the top surface of the base portion; and
a second cover member coupled to the first cover member and disposed partly on the bottom surface of the base portion, wherein the first cover member and the second cover member are together configured to removably enclose the elongate portion therein.

11. The heating system of claim 9, further comprising a mesh coupled to at least one of the top plate and the bottom plate, the mesh configured to secure the second heating member to at least one of the top plate and the bottom plate.

12. The heating system of claim 9, further comprising:
a plurality of connectors disposed on at least one of the top plate and the bottom plate; and
a wire routed around the connectors, the wire configured to secure the second heating member to at least one of the top plate and the bottom plate.

13. The heating system of claim 9, wherein each of the top plate and the bottom plate defines at least a first cutout to facilitate mounting of the casing on the component.

14. The heating system of claim 9, wherein at least one of the top plate and the bottom plate defines at least a second cutout to facilitate mounting of the base portion on a fixture.

15. The heating system of claim 9, further comprising a power source connected to at least one of the first heating member and the second heating member, the power source configured to selectively supply power to at least one of the first heating member and the second heating member.

16. The heating system of claim 9, further comprising a temperature sensing device configured to be in contact with an outer surface of the elongate portion, wherein the temperature sensing device configured to generate signal indicative of a temperature of the outer surface of the elongate portion.

17. A method of heating a component having a base portion and an elongate portion extending from the base portion, the method comprising:
providing a first heating member on the elongate portion;
enclosing the elongate portion with a casing; and
heating, via the first heating member, the elongate portion of the component.

18. The method of claim 17, further comprising providing an insulating material within the casing to enclose the first heating member.

19. The method of claim 17, further comprising:
providing a second heating member on a top surface of the base portion;
providing a top plate on the top surface of the base portion, wherein the top plate comprises an insulating layer on a surface adjacent to the top surface of the base portion; and
heating, via the second heating member, the base portion of the component.

20. The method of claim 19, further comprising:
providing the second heating member on a bottom surface of the base portion;
providing a bottom plate on the bottom surface of the base portion, wherein the top plate comprises an insulating layer on a surface adjacent to the bottom surface of the base portion; and
heating, via the second heating member, the base portion of the component.
